(19) United States
(12) Patent Application Publication
(10) Pub. No.: US 2010/0225080 A1
(43) Pub. Date: Sep. 9, 2010

(54) Articulated Two-piece Wheeled Sport Board with Rigid Flexible Connector

(76) Inventor: Shane Smith, Malibu, CA (US)

Correspondence Address: AVERILL & GREEN, 8244 PAINTER AVE., WHITTIER, CA, 90602, US

(21) Appl. No.: 12/719,422

(22) Filed: Mar. 8, 2010

Related U.S. Application Data
(60) Provisional application No. 61/209,587, filed on Mar. 9, 2009.

(51) Int. Cl. B62M 1/00

(52) U.S. Cl. 280/87.042

(57) ABSTRACT

A two-piece articulated skateboard includes two sections connected by a connector. Standard skateboard trucks and wheels are attached to the sections at opposite ends of the articulated skateboard and swiveling casters are attached to the bottom of each section and positioned towards the connector. When riding like a one-piece skateboard, the rider's feet are placed over the trucks and the swiveling casters do not touch the ground. The connector only allows enough vertical movement around the lateral axis so that when the rider shifts his weight towards the connector, the swiveling casters are lowered to the ground and engaged, enabling the two-piece articulated skateboard to slide sideways. The connector provides for a small amount of left-to-right motion around the vertical axis, providing the ability to bend the board while in a slide and to facilitate turns and stops.

The present application claims the priority of U.S. Provisional Patent Application Ser. No. 61/209,587 filed Mar. 9, 2009, which application is incorporated in its entirety herein by reference.

### BACKGROUND OF THE INVENTION

The present invention relates to sporting boards and in particular to two piece wheeled sporting boards.

Wheeled sporting boards include boards with vertical handles, such as scooters, and boards without vertical handles, such as skateboards and mountain boards. The most common wheeled sporting board is a skateboard. Known skateboards comprise a one piece elongated board, usually made of layers of laminated wood, with trucks attached to the underside of the board at opposite ends, each truck having two wheels. Riders typically stand on the board with feet pointing perpendicular to board's length.

Known skateboards are turned either by leaning the board in the direction of the turn, or for a quicker turn, by lifting up one set of wheels or the entire board and pivoting on the remaining wheels or in the air. Maneuverability with all four wheels on the ground is somewhat limited because amount the wheels turn when the board is leaned, is limited by the structure of the trucks.

### BRIEF SUMMARY OF THE INVENTION

The present invention addresses the above and other needs by providing two-piece articulated skateboard which includes two sections connected by a connector. Known skateboard trucks and wheels are attached to the sections at opposite ends of the articulated skateboard and swiveling casters are attached to the bottom of each section and positioned towards the connector. When riding like a one-piece skateboard, the rider's feet are placed over the trucks and the swiveling casters do not touch the ground. The connector only allows enough vertical movement around the lateral axis so that when the rider shifts his weight towards the connector, the swiveling casters are lowered to the ground and engaged, enabling the two-piece articulated skateboard to slide sideways. The connector provides for a small amount of left-to-right motion around the vertical axis, providing the ability to bend the board while in a slide and to facilitate turns and stops.

In accordance with one aspect of the invention, there is provided an articulated skateboard having two board sections connected by connector having limited flex. The connector is designed to freely allow left-to-right (e.g., yaw) movement of one of the board sections with respect to the other board section (about a vertical axis), but resist vertical movement (e.g., pitch) of one board section with respect to the other (around the lateral axis) to provide a stiff but springy platform.

In accordance with another aspect of the invention, there is provided an articulated skateboard having two board sections. Each section has a regular set of skateboard trucks with wheels, and in addition, each section has a swivelling caster positioned on each board section near the connector. Bending the connector and pointing the front section to the right or the left changes the direction of travel from a straight line to the direction the front section is pointing. Bending the connector a greater amount allows the rider to turn in tighter circles than known skateboards to perform new tricks. When the rider moves his weight from the front and rear ends of the articulated skateboard towards the center, the rider's weight deflects the connector slightly downward, engaging the swivelling casters and allowing the articulated skateboard to move sideways or in a direction not limited by the skateboard trucks and wheels. Thus, the present invention gives the rider three degrees of increased manoeuverability over known skateboards—the left-right flex of the connector for increased turning, the increased vertical springiness for more energy entering into tricks, and the ability to ride sideways by engaging the 360 degree swivelling casters.

In accordance with yet another aspect of the invention, there is provided an articulated skateboard which provides more opportunities for tricks and enjoyment by having a flexible connector joining two sections. The articulated skateboard is more maneuverable than known skateboards due to the flexible connection between the two sections providing a different type of articulated skateboard to ride. The articulated skateboard allows the rider to ride in a direction other than that of the fixed wheels.

In accordance with still another aspect of the invention, there is provided an articulated skateboard which may be turned more easily and more quickly than known skateboards without the need to lift one or more wheels off of the ground providing greater maneuverability than the known skateboard. The articulated skateboard further provides the ability to do new tricks such as turn tighter circles and slide sideways on the swivelling casters. The connector of the articulated skateboard provides additional springiness over existing skateboards, providing the ability to jump higher when doing tricks on the board.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a top view of a two-piece articulated skateboard according to the present invention.

FIG. 2 is a bottom view of the articulated skateboard according to the present invention.

FIG. 3 is a perspective view of the articulated skateboard according to the present invention.

FIG. 4 is a side view of the articulated skateboard according to the present invention.

FIG. 5A is a side view of an alternate embodiment of the articulated skateboard according to the present invention, with the connector mounted on the bottom surface rather than on the top surface of the sections.

FIG. 5B is a side view of an alternate embodiment of the articulated skateboard according to the present invention, with the connector mounted so that part of the connector is above and part of it is below the horizontal plane of the sections.

FIG. 6A is a detailed cross-sectional view of a connector according to the present invention, taken along line 6A-6A of FIG. 1.

FIG. 6B is a top sectional view of a connector according to the present invention, taken along line 6B-6B of FIG. 3.

FIG. 6C is a partial perspective sectional view of a connector according to the present invention.

FIG. 7A is a side view of an alternate embodiment of the articulated skateboard according to the present invention, with one truck and its set of fixed wheels replaced with a swivelling caster wheel.

FIG. 7B is a side view of an alternate embodiment of the articulated skateboard according to the present invention, with each of the trucks replaced with casters, and with two casters placed towards the connector.

FIG. 7C is a side view of an alternate embodiment of the articulated skateboard according to the present invention, with only one caster on each section.

FIG. 8A is a bottom view of the alternate embodiment shown in FIG. 7A.

FIG. 8B is a bottom view of the alternate embodiment shown in FIG. 7B.

FIG. 8C is a bottom view of the alternate embodiment shown in FIG. 7C.

FIG. 9A is a bottom view of an alternate embodiment of the articulated skateboard according to the present invention, with two trucks placed towards the connector and two casters placed away from the connector.

FIG. 9B is a bottom view of an alternate embodiment of the articulated skateboard according to the present invention, with only two trucks, one on each section.

FIG. 10A is a side view of an alternate embodiment of the articulated skateboard according to the present invention with a connector comprised of a hinge.

FIG. 10B is a perspective view of the hinged connector shown in FIG. 10A.

FIG. 11A is a detailed cross-sectional view of an alternate embodiment of the connector with a filler according to the present invention, taken along line 6A-6A of FIG. 1.

FIG. 11B is a detailed cross-sectional view of an alternate embodiment of the connector with an internal spring according to the present invention, taken along line 6A-6A of FIG. 1.

FIG. 11C is a detailed cross-sectional view of an alternate embodiment of the connector with an internal rod according to the present invention, taken along line 6A-6A of FIG. 1.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

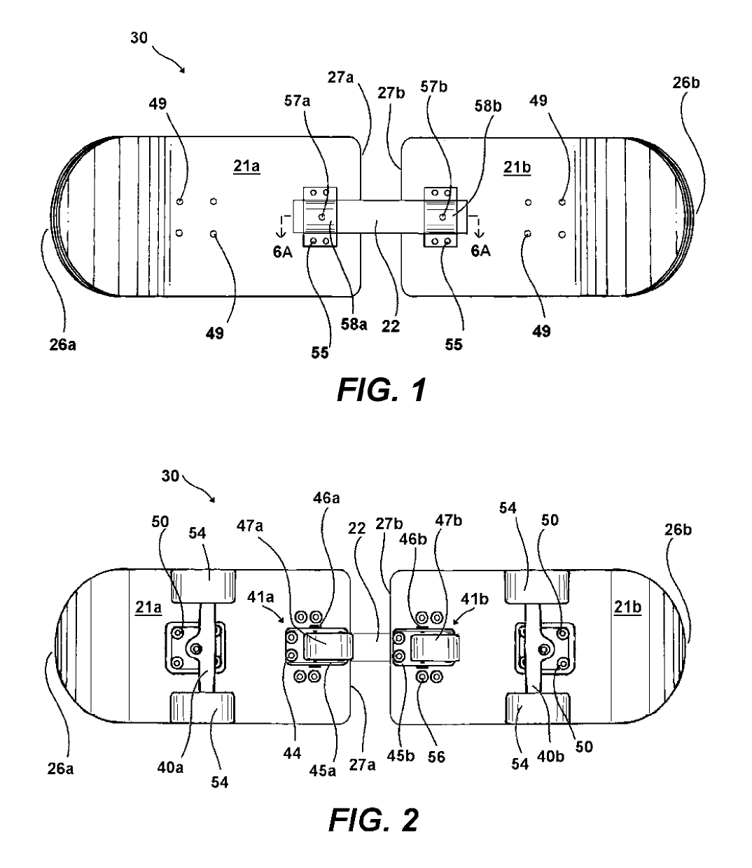

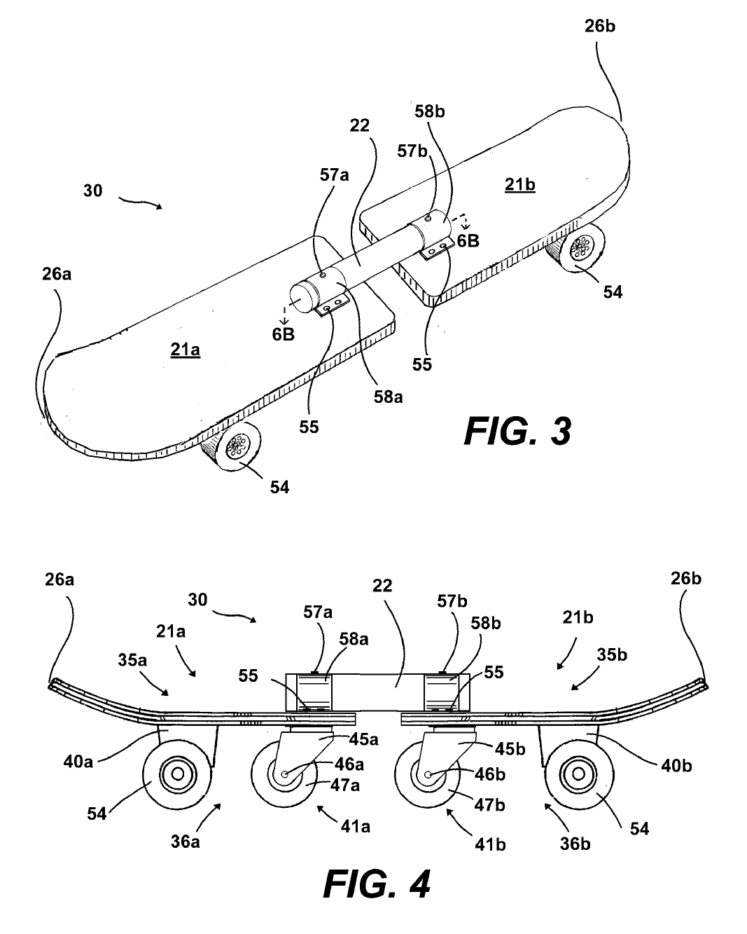

A top view of an articulated skateboard 30 according to the present invention is shown in FIG. 1, a bottom view of the articulated skateboard 30 is shown in FIG. 2, a perspective view of the articulated skateboard 30 is shown in FIG. 3, and a side view of the articulated skateboard 30 is shown in FIG. 4. The articulated skateboard 30 comprises a first section 21a and a second section 21b connected by a connector 22. The sections 21a and 21b may be substantially identical or they may differ in size, shape, length, width, height, thickness or construction to alter the performance characteristics of the articulated skateboard 30. Further, the sections 21a and 21b, while normally the same width and length as one another, may differ in width or in length or in height or thickness or shape or construction or any other parameter, so that one section may be wider or longer or different in one or many other ways than the other section. The sections 21a and 21b have leading edges 26a and 26b respectively and trailing edges 27a and 27b respectively. The sections 21a and 21b are preferably constructed of any material which may be used in the construction of the decks of known or future skateboards or articulated skateboard including but not limited to plastics or wood, or any material with similar characteristics thereof.

The connector 22 is attached to sections 21a and 21b preferably with a clamp 58a and 58b fastened with a bolt 57a and 57b, respectively, and bolts or screws 55, although any method of connection may be used. For example, the ends of the connector 22 may be fastened directly to the sections 21a and 21b, or the connector 22 may be overmolded with a plastic and then the overmolding affixed to the sections 21a and 21b with glue or fasteners. The distance between section 21a and section 21b, determined by the length and position of the connector 22, is preferably between approximately ¼ inch and approximately six inches, and more preferably between approximately ¼ inch and approximately two inches, and most preferably the distance between section 21a and 21b is approximately ½ inch. The connector 22 preferably has a diameter between approximately 0.25 inches and approximately two inches, and more preferably has a diameter of approximately one inch.

In an alternative embodiment, the trailing edges 27a and 27b are rounded and the separation of the between section 21a and section 21b is approximately ⅛ inch.

As seen in the bottom view of the articulated skateboard 30 in FIG. 2, skateboard trucks 40a and 40b are attached to bottom surfaces 36a and 36b of the sections 21a and 21b respectively, with bolts 49 and secured with nuts 50. Two wheels 54 are mounted onto each of the trucks 40a and 40b.

Caster assemblies 41a and 41b are located on the bottom surfaces 36a and 36b, respectively, each preferably positioned close to the trailing edges 27a and 27b, respectively. The caster assemblies 41a and 41b are preferably swivel casters which can rotate 360 degrees, as opposed to a fixed, rigid caster. The caster assemblies 41a and 41b each preferably comprise wheel holders 45a and 45b, axles 46a and 46b and wheels 47a and 47b, respectively. However, any functionally dependable method of attaching a wheel can be used. The wheels 54 which are attached to the trucks 40a and 40b are preferably the primary wheels in contact with the ground during straight and level riding of the articulated skateboard 30. The rider can shift his weight towards the trailing edges 27a and/or 27b in order to additionally engage the wheel 47a and/or 47b, respectively, to provide different riding characteristics, such as the ability to move sideways or at an angle on the swiveling caster wheels 47a and 47b.

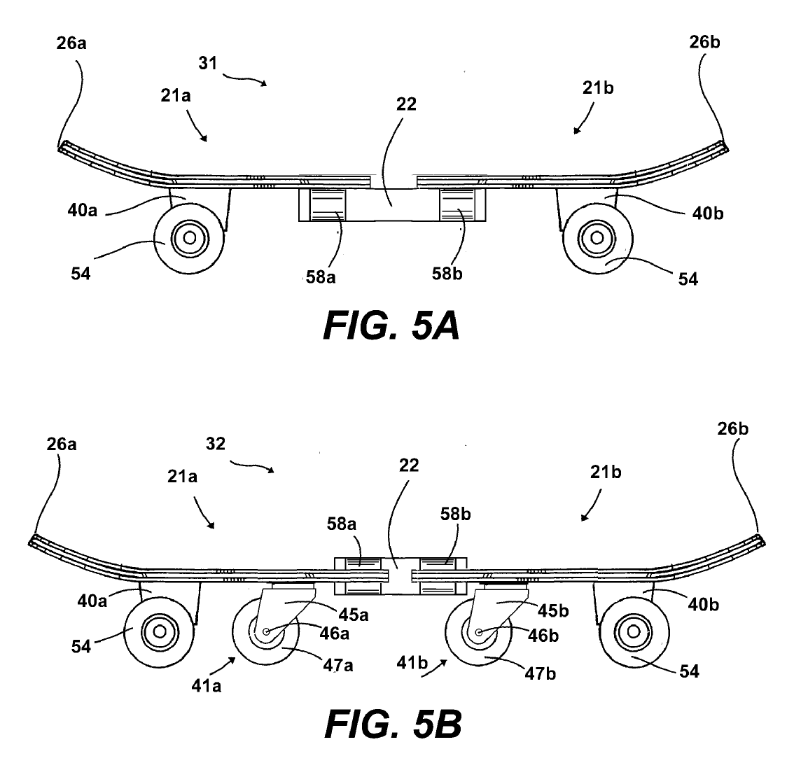

The placement of the connector 22 on the top surfaces 35a and 35b in order to connect sections 21a and 21b to one another, respectively is shown in FIG. 4. An alternate embodiment is shown in FIG. 5A, where the connector 22 is placed under the sections 21a and 21b, and is fastened to the bottom surfaces 36a and 36b, respectively. This embodiment has the advantage of providing more space on the top surfaces 35a and 35b for the rider's foot. Another alternate embodiment is shown in FIG. 5B, where the connector 22 is positioned and connected so that it is partially above and partially below the sections 21a and 21b. This embodiment would provide less obstruction on the top surfaces 35a and 35b than the preferred embodiment, and if molded in place, could provide a relatively unobstructed platform for riding.

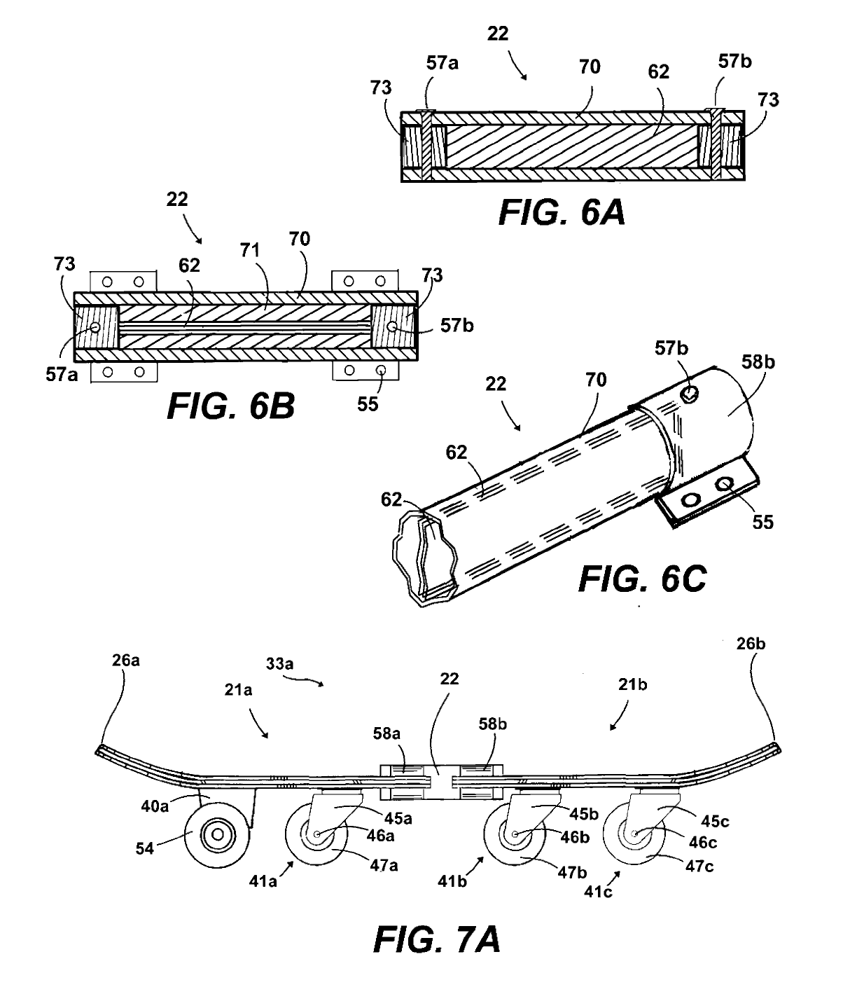

Connector 22, as shown in FIGS. 6A, 6B and 6C, is preferably comprised of a set of one or more plates 62 oriented vertically on edge, and preferably three vertical spring steel blades oriented vertically on edge with approximate dimensions 0.062 inches×¾ inches, and positioned inside hose 70 so that the ¾ inch dimension is vertical. A filler 71, such as a urethane rubber, fills the space around the vertical plates 62, although a wide range of materials of varying degrees of hardness and flexibility can be used for filler 71 and also filler 71 may be omitted. The connector 22 is sealed with a plug 73, preferably made of an Ultra-High Molecular Weight (UHMW) plastic, and more preferably a UHMW Polyethylene, although a variety of materials can be used, including but not limited to urethane, metal, wood and various plastics. The plates 62 can be replaced with a different number of plates of different widths and heights, and materials. For example, one plate could be used, or four plates, and a hard plastic or another type of metal could be used, as long as the resultant connector 22 allows left-to-right movement but restricts vertical movement of one section with respect to the other section.

The flexure of connector 22 will be the result of the combined flexure characteristics of hose 70, filler 71 and plates 62. The various flexures of the connector 22 provide a different ride or feel for the rider, and a connector 22 with less flexure may be more desirable for some conditions or riders, and a connector 22 with more flexure may be more desirable for other conditions or riders. The connector 22 is preferably substantially non-compressible in length, although a small amount of compression is allowable as long as the sections 21a and 21b do not contact as a result of compression of the connector 22. An example of suitable hose 70 for connector 22 is a length of reinforced hydraulic hose such as Parker Hannifin® 471 ST-16 hose or similar hose having two braids of steel wire. However, the present invention is not limited to a specific hose type, and another example of a suitable hose is Parker Hannifin® 721^{ST}-16; suitable hoses may have zero to four braids of steel wire, and may be other hydraulic hose, air-conditioning hose, pneumatic hose, and the like, including any connector that is molded, such as one of rubber or plastic, and has similar characteristics. Any two-piece articulated skateboard with a connector having physical characteristics similar to the characteristics of the Parker Hannifin® 471ST-16 hose with an internal set of blades 62 oriented vertically on edge, is intended to come within the scope of the present invention. An alternate embodiment of connector 22 would be vertical plates 62 attached directly to sections 21a and 21b without the hose 70.

The connector 22 preferably allow the articulated skateboard 30 to flex horizontally (i.e., right/left) between zero and preferably about 15 degrees at preferably one degree per one to four ft/lbs of torque, and more preferably one degree per two to three ft/lbs of torque. The connector 22 preferably allow the articulated skateboard 30 to flex vertically (i.e., up/down) sufficiently to shift at least half the weight of the articulated skateboard 30 from a pair of trucks at opposite ends of the articulated skateboard 30 to a pair of castors attached to the sections between the trucks and the connector, for the rider. Because the weight of riders can vary significantly, riders of different weight and different skill level may prefer connectors having different flex characteristics.

An articulated skateboard 30 rider places a first foot on the top surface 35a of section 21a and a second foot on the top surface 35b of 21b, preferably, with feet at angles to the longitudinal axis in a stance similar to that used by traditional skateboarders. While riding, the connector 22 allows some lateral (right or left) flex around the vertical axis, but preferably has limited vertical (up and down) flex. This characteristic is provided primarily by the action of the vertical plates 62, which flex left-to-right, but not up-and-down. It is also controlled by the hose 70, which not only acts as a container for the blades 62, but also provides flex characteristics which contribute to the total flex characteristics of the connector 22.

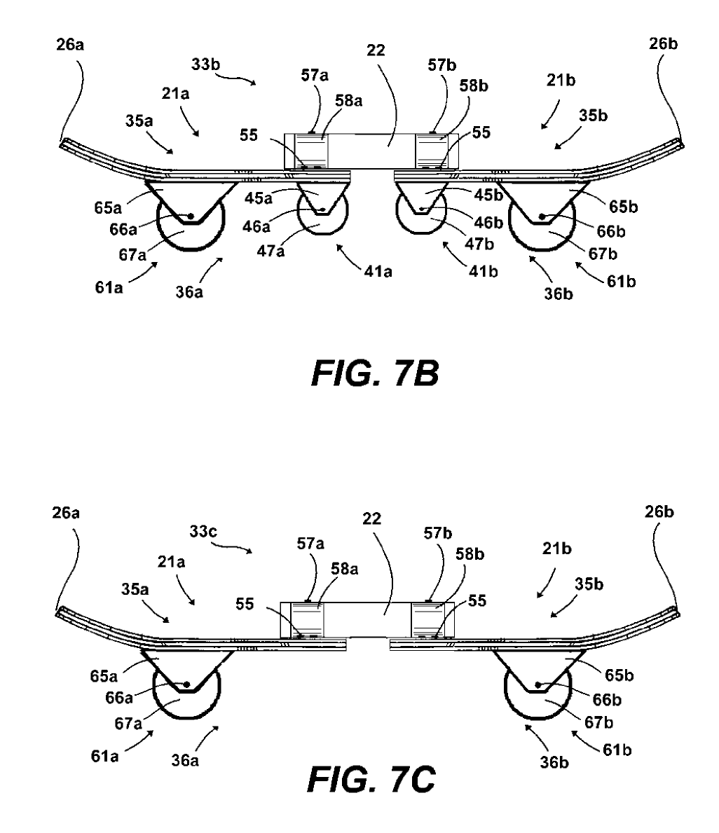

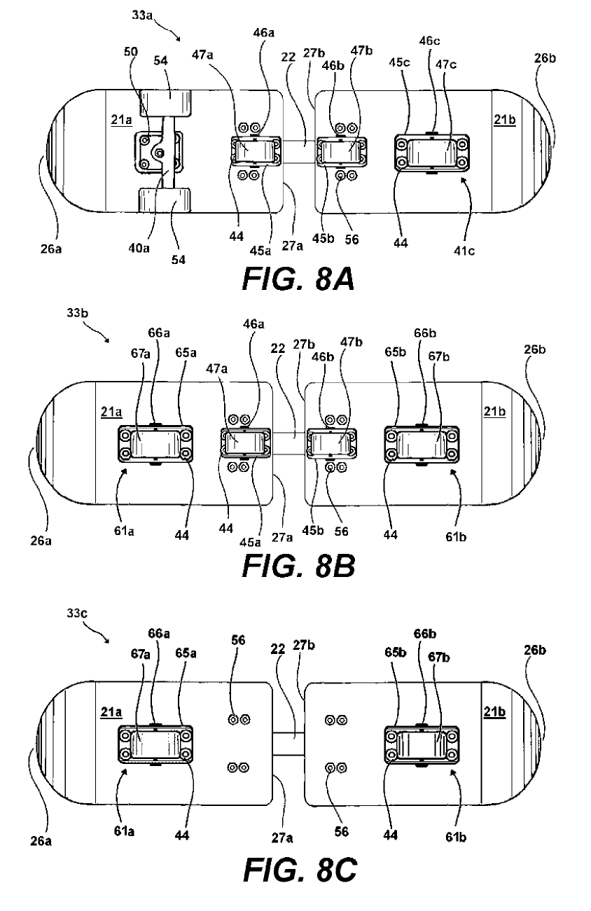

FIGS. 7A, 7B, 7C, 8A, 8B, 8C, 9A, and 9B show alternate embodiments of different types of wheels and positioning of wheels on the bottom surfaces 36a and 36b to provide various riding experiences for the rider. FIG. 7A is a side view and FIG. 8A is a bottom view showing an articulated skateboard 33a with a truck 40a with two wheels 54 positioned towards the leading edge 26a of section 21a, a preferable swivelling caster assembly 41c positioned towards the leading edge 26b of section 21b, and preferably two caster assemblies 41a and 41b positioned towards the trailing edges 27a and 27b of sections 21a and 21b, respectively.

FIG. 7B is a side view and FIG. 8B is a bottom view showing an articulated skateboard 33b with a preferable caster assembly 61a positioned towards the leading edge 26a of section 21a, a preferable caster assembly 61b positioned towards the leading edge 26b of section 21b, and preferably two caster assemblies 41a and 41b positioned towards the trailing edges 27a and 27b of sections 21a and 21b, respectively.

FIG. 7C is a side view and FIG. 8C is a bottom view showing an articulated skateboard 33c with a preferable caster assembly 61a on the bottom surface 36a of section 21a, and a preferable caster assembly 61b positioned on the bottom surface 36b of section 21b.

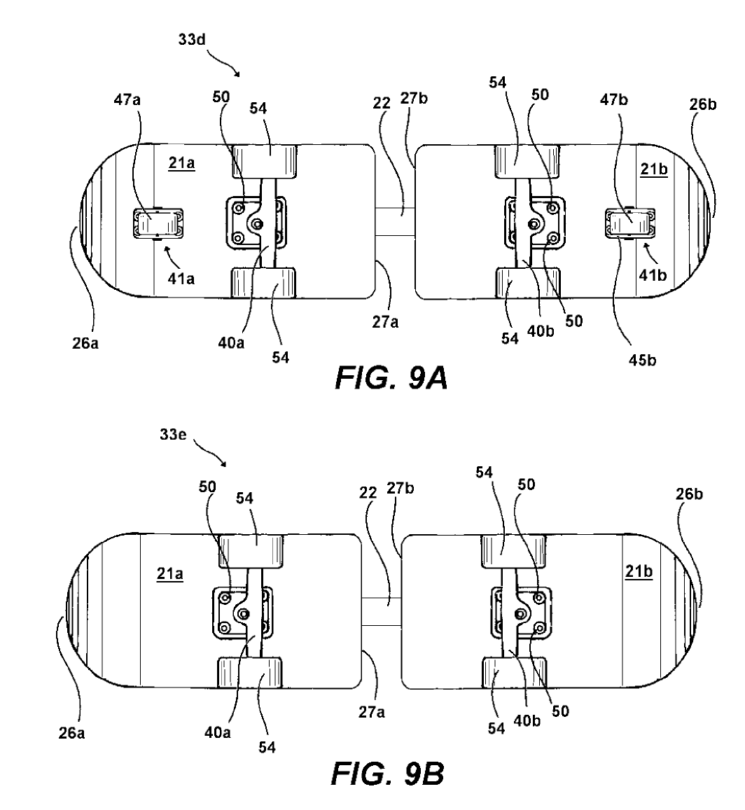

FIG. 9A. is a bottom view showing an articulated skateboard 33d with a preferable caster assembly 41a positioned towards the leading edge 26a of section 21a, a preferable truck 40a with two wheels 54 positioned towards the trailing edge 27a of section 21a, a preferable caster assembly 41b positioned towards the leading edge 26b of section 21b, and a preferable truck 40b with two wheels 54 positioned towards the trailing edge 27b of section 21b. In this embodiment, the wheels 54 would be in contact with the ground during normal riding, and the wheels 47a and/or 47b of the caster assemblies 41a and 41b would be engaged for special tricks by moving the rider's weight more towards the leading edges 26a and/or 26b.

FIG. 9B. is a bottom view showing an articulated skateboard 33e with a preferable truck 40a with two wheels 54 positioned on the bottom surface 36a of section 21a, and a preferable truck 40b with two wheels 54 positioned on the bottom surface 36b of section 21b.

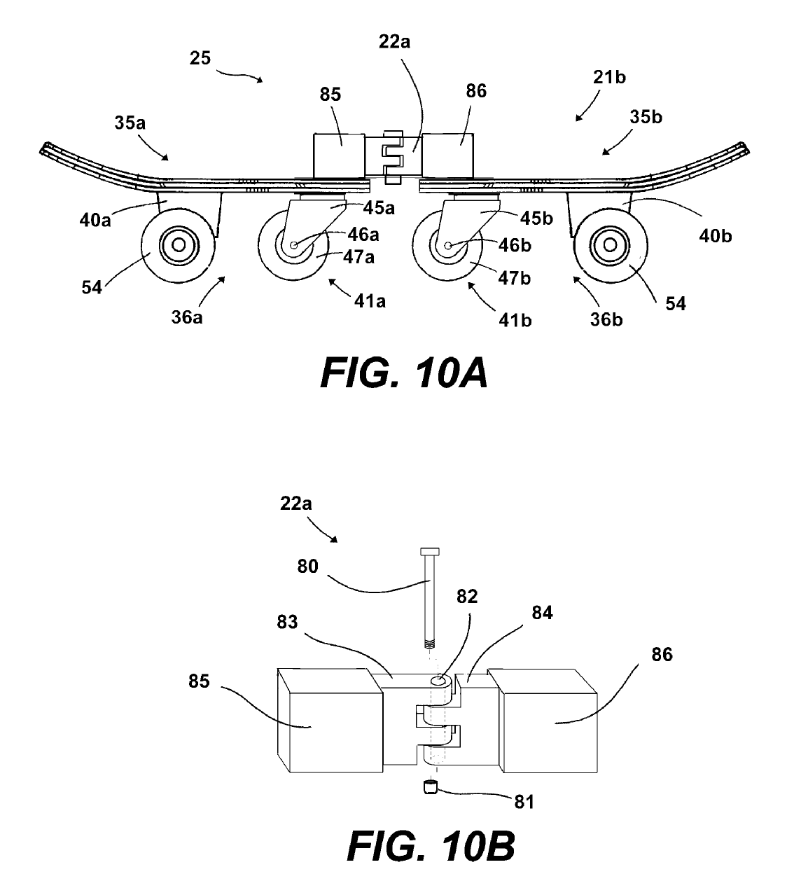

FIG. 10A is a side view showing an alternate embodiment of an articulated skateboard 25 with a hinged connector 22a. The connector 22a is constructed to limit vertical up-and-down flex while allowing left-to-right flex. Referring to FIG. 10B, this is accomplished with a left hinge segment 83 and a right hinge segment 84 joined together with a bolt 80 and a nut 81. Hinge segment 83 and 84, respectively, are molded into a block 85 and a block 86, which are affixed to the sections 21a and 21b. The hinged connector 22a could also be encased in a hydraulic hose in a manner similar to that used in the connector 22. The preferred embodiment connecter 22 and the alternate embodiment connector 22a are not intended in any way to restrict the construction of the connector to those described herein. Any type of connection between sections 21a and 21b that provides the ability to flex horizontally while restricting vertical flex is intended to be within the scope of the present invention.

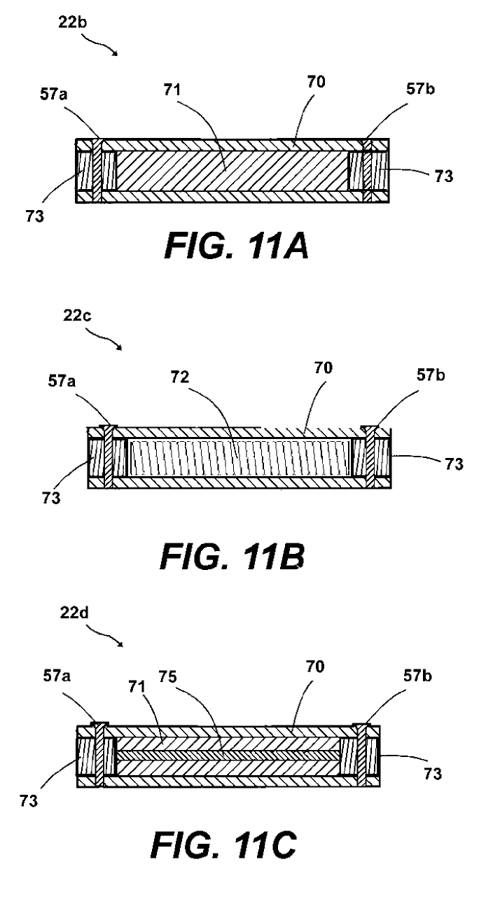

FIGS. 11A, 11B and 11C show alternate embodiments of connector 22, taken along line 6A-6A of FIG. 1, and differ from connector 22 because they do not restrict vertical flex, but are able to flex equally vertically and horizontally, while restricting twist around the longitudinal axis. The connector 22b in FIG. 11A comprises a hose 70, a flexible material 71 with characteristics preferably similar to a soft urethane, a plug 73 preferably of UHMW or a hard urethane or any similar material at each end of the hose 70, and preferably a bolt 74 or any material that secures the hose 70 to the plug 73 at each end. Connector 22b will have equal vertical and horizontal flex. The connector 22c of FIG. 11B is similar to 22b except that it contains a spring 72 instead of, or in addition to, the flexible material 71. The connector 22d of FIG. 11C is similar to the connector 22b except that it contains a rod 75 of a stiff material such as, but not limited to, metal or a hard plastic that is embedded into each plug 73, and may or may not have the flexible material 71 surrounding it.

The connector 22b shown in FIG. 11A is substantially the same connector described in detail in Shane Smith's pending patent application Ser. No. 11/299,257 titled “Articulated two-piece snowboard with rigid, flexible connector”, which patent is incorporated by reference in its entirety. The alternate embodiments of the connector of the present invention shown in FIGS. 11B and 11C use a similar hose 70 as that in FIG. 11A. These alternate embodiments are shown as some possible variations of a hose that can flex in any direction and are not intended to restrict the construction of the connector in any way. The construction of the connector can be any construction that results in the same or in similar characteristics.

The preferred and alternate embodiments may have any arrangement of wheels on the bottom surface of the articulated skateboard, and the descriptions herein are not intended in any way to restrict the position or type of wheels used, but are only meant to demonstrate some of the possible combinations. For example, any of the caster assemblies (whether swivelling caster assembly or a fixed caster assembly), and/or any of the trucks with wheels, can be replaced with a truck with two wheels, or with a swivelling caster assembly or with a fixed caster assembly (either caster assembly can be either plate mounted or stem mounted), or any type of wheel or truck that is currently available for any articulated skateboards on the market or which will become available for any articulated skateboards in the future.

Further, the types of wheels are not restricted to the descriptions herein. In the same manner, the position of the wheels can vary and may be placed farther from or closer to the leading edges 26a and 26b or the trailing edges 27a or 27b, or may be placed off-center rather than on the center line as depicted in the drawings herein. Additionally, more wheels or fewer wheels may be added in any arrangement or number or placement to the bottom surfaces 36a or 36b of sections 21a and 21b, respectively. Specifically, the sport boards 30, 32, 33a and 33b in FIGS. 4, 5B, 7A and 7B, respectively, may omit one of the caster assemblies such as 41a while retaining the other, such as 41b, so that one board section has a caster assembly located towards the connector and the other section does not, or the single caster assembly may be connected directly to the connector. Additionally, the bottom surface of the wheels in relation to the ground may vary; that is, (1) all wheels on a board may touch the ground, or (2) only some may touch the ground in straight and level riding while others may only be engaged when the rider shifts his weight. The purpose of the drawings of the various embodiments is to demonstrate the variety of wheels and wheel placements that can be accomplished with the present invention and is not meant to restrict the present invention to the examples that have been explicitly shown herein.

It may be desirable to easily connect and disconnect the sections. To this end, the connector can be secured with removable pins or bolts. In an alternative embodiment for commercial production and use, the connector end can be connected in a way that is easily disconnected and reconnected such as a removable pin, clamp or snap-in device.

The performance characteristics of the invention can be modified by using connectors that differ in length, diameter or ease of flexing. In addition, connectors can be varying lengths to accommodate the stride of different sized riders.

Accordingly, those skilled in the art will recognize that, due to its two-piece, articulated construction and the stiff but flexible connector with restricted vertical flex, this invention offers a rider capabilities not heretofore experienced. Maneuverability and the ability to perform new tricks and enjoy new riding styles are enhanced by the two-piece construction, the flexibleness of the connector and the various options for wheel type and placement.

The connector can be constructed with a universal connection apparatus so that sections and connectors can be easily interchanged, giving a rider a wide variety of performance choices, as well as the advantage of being able to easily dismantle the invention into sections and connector for easy transport and storage.

The advantage of this invention over previous articulated skateboards are as follows:

two piece construction provides increased maneuverability and riding options and tricks;

semi-rigid, flexible connector provides increased maneuverability and riding options and tricks;

swiveling casters located towards the connector provides the ability to ride sideways, increasing maneuverability; and

restricted vertical (up and down) movement of the connector provides a springy board and more energy for tricks.

While the invention herein disclosed has been described by means of specific embodiments and applications thereof, numerous modifications and variations could be made thereto by those skilled in the art without departing from the scope of the invention set forth in the claims.

I claim:

1. An articulated skateboard, comprising:
front and rear sections including rider supporting upper surfaces;
said front and rear sections connected by a connector providing the sections with easy right and left motion as viewed from the top and very restricted up and down motion as viewed from the side;
at least one fixed wheel positioned on the underside of each section residing away from the connector; and
at least one swiveling caster residing on the underside of one of the sections between one of the fixed wheels and the connector.

2. The two-piece articulated skateboard of claim 1, wherein the at least one swiveling caster comprises two swiveling casters, one located on each section and positioned towards the connector.

3. The two-piece articulated skateboard of claim 1, wherein the connector includes a length of one or more pieces of flat spring steel oriented vertically so that the taller dimension is viewed from the side and the narrow dimension is viewed from the top of the board.

4. An articulated skateboard, comprising:
front and rear sections including rider supporting upper surfaces;
said front and rear sections connected by a connector providing the sections with easy right and left motion as viewed from the top and more restricted up and down motion as viewed from the side;
a skateboard truck attached to the bottom of each section residing away from the connector;
two skateboard wheels attached to each truck; and
a swiveling caster residing on the underside of each of the sections between the skateboard trucks and the connector.

5. An articulated skateboard, comprising:
front and rear sections including rider supporting upper surfaces;
said front and rear sections connected by a connector providing the sections with easy right and left motion as viewed from the top and more restricted up and down motion as viewed from the side, the connector includes one or more lengths of flat spring steel oriented vertically on edge so that the taller dimension is viewed from the side and the narrow dimension is viewed from the top of the board;
a skateboard truck attached to the bottom of each section residing away from the connector;
two skateboard wheels attached to each truck; and
a swiveling caster residing on the underside of each of the sections between the skateboard trucks and the connector.
